(19) United States
(12) Patent Application Publication
(10) Pub. No.: US 2016/0026305 A1
(43) Pub. Date: Jan. 28, 2016

(54) SHADELESS TOUCH HAND-HELD ELECTRONIC DEVICE AND TOUCH-SENSING COVER THEREOF

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/721,861

(22) Filed: May 26, 2015

(30) Foreign Application Priority Data
Jul. 25, 2014 (CN) 201410361649.6
Jul. 25, 2014 (CN) 201410361701.8

(51) Int. Cl. G06F 3/047; G09G 5/00; G06F 3/01; G06F 3/044

(52) U.S. Cl. CPC G06F 3/047; G06F 3/044; G09G 5/003; G06F 3/013; G09G 2300/04

(57) ABSTRACT

A shadeless touch hand-held electronic device and a touch-sensing cover thereof are disclosed. The shadeless touch hand-held electronic device comprises a panel and a control unit. The touch-sensing cover comprises a cover and a touch-sensing structure. The cover comprises a cover body and a sidewall extended from at least a part of an edge of the cover body. At least a part of the touch-sensing structure is disposed on the cover body. The cover is disposed on the side of the shadeless touch hand-held electronic device opposite the panel, and the touch-sensing structure is electrically connected with the control unit, so that a user operates the shadeless touch hand-held electronic device by the touch-sensing cover.

### CROSS REFERENCE TO RELATED APPLICATIONS

This Non-provisional application claims priority under 35 U.S.C. §119(a) on Patent Application No(s). 201410361701.8 and 201410361649.6 filed in People's Republic of China on Jul. 25, 2014, the entire contents of which are hereby incorporated by reference.

### BACKGROUND OF THE INVENTION

1. Field of Invention

This invention relates to a hand-held electronic device and a touch-sensing cover thereof and, in particular, to a shadeless touch hand-held electronic device and a touch-sensing cover thereof.

2. Related Art

With the progress of technologies, various novel information devices are invented, such as cell phones, tablet computers, ultrabooks and GPS (Global Positioning System) navigation devices. Generally, a keyboard and mouse are commonly used to manipulate the information device for inputting information. Besides, the touch control technology currently also becomes a popular manipulation method for the information device and brings an intuitive operation. Accordingly, a touch display device using the touch control technology can provide a friendly and intuitive interface for the input operation, and therefore users of all ages can manipulate the touch display device by fingers or a stylus.

In a common and conventional hand-held electronic device with the touch function, the touch operations are all directly executed on the display panel. However, for the operation on the panel, fingers will shade the user's view or the functional item displayed on the display panel, such that the user may erroneously touch, by the finger, an undesired one of the items which are arranged in a high information content density on the display panel. In order to avoid the above situation, some electronic devices adopt a design where the touch operation area is separated from the display panel, such as disclosed by the U.S. Pat. No. 5,825,352 (Logitech).

However, such design will increase the volume of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the view shading problem of the hand-held electronic device caused by the finger.

Besides, the frequent touch operation on the panel of the electronic device will scratch the panel. Moreover, in the common use of the hand-held electronic device with the touch function, one hand is used to hold the electronic device while the other hand is used to operate on the panel. Hence, if only a single hand holds and operates the device at the same time, the touch operation can be just executed by the thumb and that is really inconvenient for the user.

Besides, when the user uses the hand-held electronic device under strong sunlight, the sunlight readability of the display panel is always a problem that can't be effectively solved. Since the user can't see the information displayed on the display panel, the two-hand operation is also ineffective and the information such as email or Facebook can't be respond promptly.

Furthermore, the touch panel needs to be configured with the rare earth transparent touch-sensing layer such as ITO (indium tin oxide) so as to be kept in high transparent display performance, but since the rare earth metal indium is unceasingly consumed, the cost of the product is getting higher and higher. Besides, the conductivity of the rare earth metal is worse than the normal metal, such that the detection sensitivity of the touch is limited. Therefore, using the rare earth transparent touch-sensing layer in the touch panel is not a good course for the environmental resources and energy conservation. Moreover, the touch range of the finger is increased with the increased size of the panel, and this will cause the corresponding increment of the area of the touch-sensing layer and the cost, and therefore the efficiency and convenience of the hand operation will be lowered down.

Therefore, a shadeless touch hand-held electronic device and a touch-sensing cover thereof can prevent the finger from shading user's view during the operation and avoid the scratch on the panel. Besides, the convenience of the single-hand operation also can be enhanced.

### SUMMARY OF THE INVENTION

An aspect of the invention is to provide a shadeless touch hand-held electronic device and a touch-sensing cover thereof whereby the finger can't shade the user's view during the operation and the scratch on the panel can be reduced and also the convenience of the single-hand operation can be enhanced.

Therefore, a touch-sensing cover of a shadeless touch hand-held electronic device is provided by this invention. The shadeless touch hand-held electronic device comprises a panel and a control unit. The touch-sensing cover comprises a cover and a touch-sensing structure. The cover comprises a cover body and a sidewall extended from at least a part of an edge of the cover body. At least a part of the touch-sensing structure is disposed on the cover body. The touch-sensing structure comprises a plurality of detection points for providing an input position. The area of the touch-sensing structure and the area of the panel have a ratio relationship. The control unit, according to the ratio relationship, converts the input position into a display position of the panel, and the panel displays a visible sign at the display position. The cover is disposed on the side of the shadeless touch hand-held electronic device opposite the panel, and the touch-sensing structure is electrically connected with the control unit, so that a user operates the shadeless touch hand-held electronic device by the touch-sensing cover.

Moreover, a shadeless touch hand-held electronic device according to this invention comprises a panel, a control unit and a touch-sensing cover. The touch-sensing cover comprises a cover and a touch-sensing structure. The cover is disposed on the side of the shadeless touch hand-held electronic device opposite the panel and comprises a cover body and a sidewall extended from at least a part of an edge of the cover body. At least a part of the touch-sensing structure is disposed on the cover body. The touch-sensing structure comprises a plurality of detection points for providing an input position. The area of the touch-sensing structure and the area of the panel have a ratio relationship. The control unit, according to the ratio relationship, converts the input position into a display position of the panel, and the panel displays a visible sign at the display position. The touch-sensing structure is electrically connected with the control unit, so that a user operates the shadeless touch hand-held electronic device by the touch-sensing cover.

In one embodiment, the touch-sensing structure is disposed on an inner surface of the cover facing the panel or on an outer surface of the cover against the panel, or a part of the touch-sensing structure is disposed on an inner surface of the cover facing the panel and another part of the touch-sensing structure is disposed on an outer surface of the cover against the panel.

In one embodiment, the touch-sensing structure comprises metal mesh, metal nanowires, transparent conducting film, carbon nanotubes or graphene.

In one embodiment, the touch-sensing structure is further extended to at least one sidewall.

In one embodiment, the control unit computes a trigger quantity distribution, trigger time, trigger frequency, trigger morphology (which can refer to appearance) or trigger location (which can refer to position) of the detection points at predetermined time intervals and compares the trigger quantity distribution, trigger time, trigger frequency, trigger morphology or trigger location with an initiative determination condition which is pre-stored in the shadeless touch hand-held electronic device.

In one embodiment, when the trigger quantity distribution, trigger time, trigger frequency, trigger morphology or trigger location conforms to the initiative determination condition, the touch-sensing structure is permitted to receive at least an input action inputted by the user.

In one embodiment, the shadeless touch hand-held electronic device further comprises an eyeball tracking module, the eyeball tracking module acquires an eyeball information, the eyeball information comprises a position information corresponding to the panel, and the position information corresponds to an object displayed on the panel.

In one embodiment, the shadeless touch hand-held electronic device further comprises a wireless communication unit, which comprises a wireless communication chip and an antenna, the wireless communication chip is electrically connected with the control unit, and the antenna is disposed on a part of the cover or the touch-sensing structure.

In one embodiment, the user operates the shadeless touch hand-held electronic device by a single hand.

In one embodiment, a part of the touch-sensing structure is capable of a wireless power transmission.

As mentioned above, in the shadeless touch hand-held electronic device and the touch-sensing cover (or called the smart cover) thereof according to the invention, the user can execute the touch operation on the touch-sensing cover of the shadeless touch hand-held electronic device, so the finger of the user can't shade the view or the software object displayed on the panel, and also the touch for opening the link of the high information density image won't be erroneously executed. Besides, since the manipulation for the electronic device is executed on the touch-sensing cover, the panel scratch situation can be reduced. Furthermore, because the user can execute the touch operation on the touch-sensing cover, the user can use multiple fingers such as the forefinger and middle finger to operate the electronic device while using the same hand holding the device. In comparison with the conventional art where the user just can use the thumb to execute the operation while using the same hand holding the device, this invention can provide more manual efficiency and convenience and can realize a better user experience.

In one embodiment, the shadeless touch hand-held electronic device is used in the strong light environment such as the outdoor sunlight or indoor high-illuminance light, the user can operate the shadeless touch hand-held electronic device by a single hand while the touch-sensing cover faces the light source of the strong light environment (or the panel faces the user) and the panel's back faces the light source of the strong light environment, so the touch-sensing cover can block the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device under the strong light source (such as the sunlight). Besides, in comparison with the conventional art where just the thumb can be used in the single-hand operation, the operation on the touch-sensing cover by the forefinger or middle finger can provide more flexibility and a new user experience with single-hand holding and multi-finger touch operation.

Additionally, on the premise that the trigger quantity distribution, trigger time, trigger frequency, trigger morphology or trigger location conforms to the initiative determination condition, the hand-held electronic device just can execute other operations. Therefore, when other users want to operate the hand-held electronic device, the operation thereof will be forbidden because the trigger quantity distribution, trigger time, trigger frequency, trigger morphology or trigger location doesn't conform to the initiative determination condition set by the original user, and therefore the security of the hand-held electronic device can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the operation of a shadeless touch hand-held electronic device of an embodiment of the invention;

FIG. 2 is a schematic block diagram of the shadeless touch hand-held electronic device in FIG. 1;

FIG. 3 is a schematic diagram of the shadeless touch hand-held electronic device of FIG. 1 in another viewing angle;

FIG. 4 is a schematic block diagram of the touch-sensing cover of an embodiment of the invention;

FIG. 5A is a schematic diagram showing the user uses two fingers to operate the touch-sensing cover;

FIG. 5B is a schematic diagram showing the capacitance change caused by two fingers nonoverlapping each other after scanning the touch-sensing structure;

FIG. 6 is a schematic diagram showing that the touch-sensing cover of the hand-held electronic device in FIG. 1 is triggered; and

FIG. 7 is a schematic diagram showing another operation of the hand-held electronic device.

### DETAILED DESCRIPTION OF THE INVENTION

The present invention will be apparent from the following detailed description, which proceeds with reference to the accompanying drawings, wherein the same references relate to the same elements.

This invention provides a design around the U.S. Pat. No. 5,825,352 (Logitech) to get rid of the patent infringement issue and also create a better user experience than the Logitech product using the above-mentioned technique.

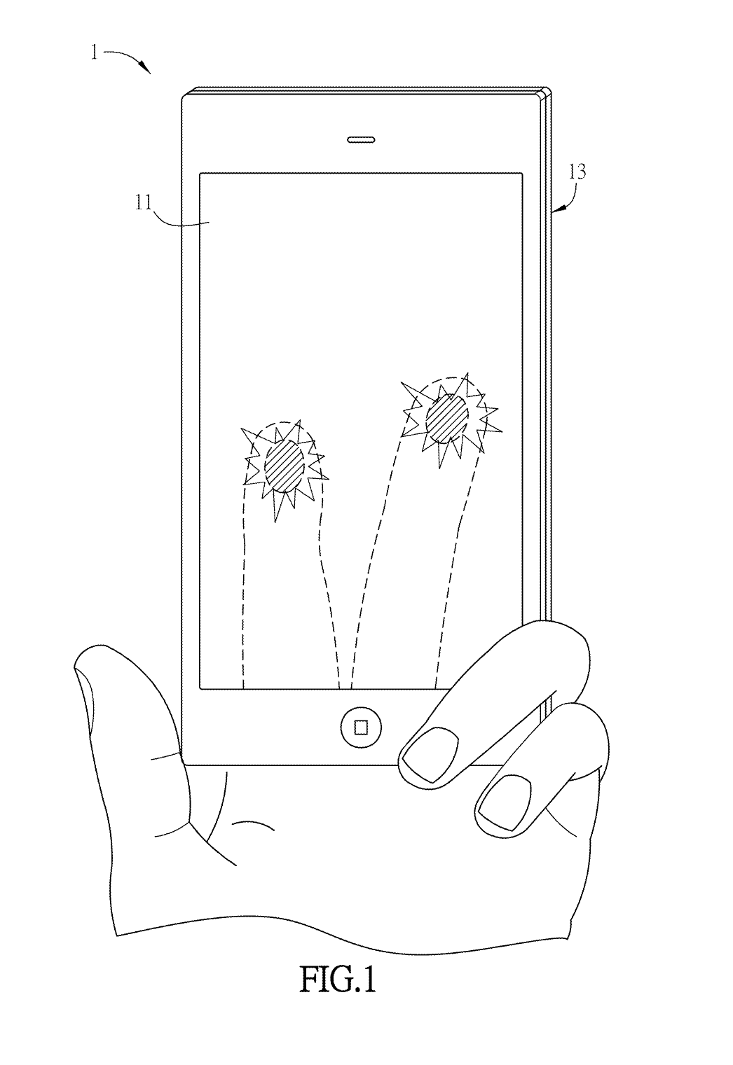

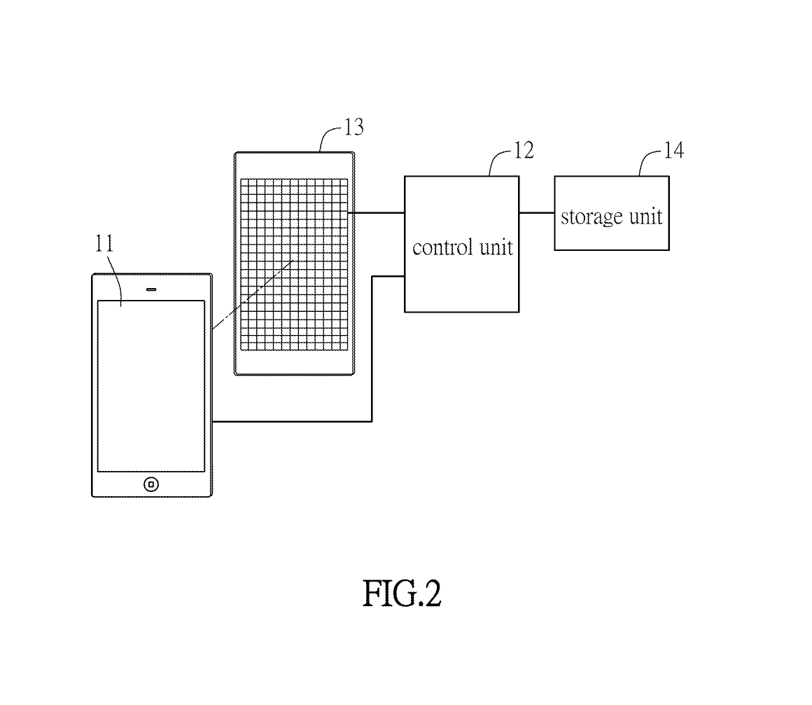

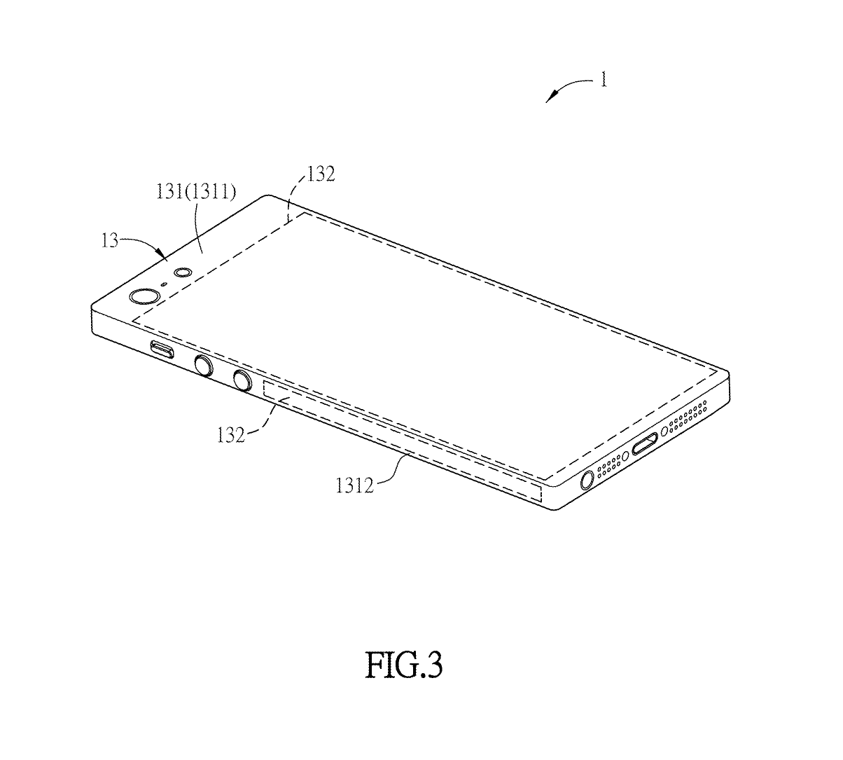

Referring to FIGS. 1 to 3, FIG. 1 is a schematic diagram showing the operation of a shadeless touch hand-held electronic device 1 of an embodiment of the invention, FIG. 2 is a schematic block diagram of the shadeless touch hand-held electronic device 1, and FIG. 3 is a schematic diagram of the shadeless touch hand-held electronic device 1 in another viewing angle.

The shadeless touch hand-held electronic device 1 (hereinafter abbreviated to hand-held electronic device 1) can be a smart phone, a tablet, a personal digital assistant (PDA), a global positioning system (GPS) device or another kind of hand-held electronic device, and herein the hand-held smart phone is illustrated as an example. Besides, the components of the hand-held electronic device 1 can be made by at least a hardware, software or firmware of the signal processing and/or integrated circuit or their any combination.

The hand-held electronic device 1 includes a panel 11, a control unit 12 and a touch-sensing cover 13. The hand-held electronic device 1 can further include a storage unit 14. The control unit 12 is electrically connected with the panel 11, touch-sensing cover 13 and storage unit 14.

The panel 11 is disposed on a side of the hand-held electronic device 1, such as the side of the hand-held electronic device 1 closer to the user's view. The panel 11 is, for example but not limited to, a liquid crystal display (LCD) panel, an organic light emitting diode (OLED) display panel, a touch display panel or an electrophoretic display panel. The panel 11 can not only display normal images but also provide the graphical user interface (GUI) for the user. The graphical user interface can show at least one figure (such as icon) on the panel 11 to exhibit any kind of the known software components.

The touch-sensing cover 13 includes a cover 131 and a touch-sensing structure 132. The cover 131 is disposed on the side of the hand-held electronic device 1 opposite the panel 11 (i.e. the opposite side of the display surface). The cover 131 includes a cover body 1311 and a sidewall 1312 extended from at least a part of an edge of the cover body 1311. The touch-sensing structure 132 is electrically connected with the control unit 12, and at least a part of the area of the touch-sensing structure 132 is disposed on the cover body 1311. In this embodiment, in addition to being disposed on the cover body 1311 (the portion of the touch-sensing structure 132 disposed on the cover body 1311 can be called the first touch-sensing structure), the touch-sensing structure 132 is further extended to the sidewalls 1312 of the two sides of the cover 131. That is, the touch-sensing structure 132 is extended from the cover body 1311 to the two sides of the cover 131 (the portion of the touch-sensing structure 132 disposed on the sidewall 1312 can be called the second touch-sensing structure), so as to increase the operation area for the user. For more effectively using the width of the cover 131 for the disposition of the touch-sensing structure 132, the width of the touch-sensing structure 132 can be slightly less than that of the cover 131 (by 5%˜10% for example). That is, the width of the touch-sensing structure 132 is about 90%˜95% that of the cover 131. In other embodiments, the touch-sensing structure 132 can be only disposed on the cover body 1311. Moreover, a physical key (such as a sound control key) can be replaced by the touch-sensing structure 132 of this embodiment, but this invention is not limited thereto. The wiring connecting to the touch-sensing structure 132 can be gathered to a single side for the wiring outlet and then electrically connected with a circuit board, so as to enhance the flexibility of the circuit design.

As to the hand-held electronic device 1 of the embodiment, the user can execute the touch operation on the touch-sensing cover 13 by finger for example, and the panel 11 can display the corresponding operation according to the user's operation gesture (or called the hand gesture), and thereby the user can interact with the graphical user interface displayed on the panel 11. For example, when the user's finger slides on the touch-sensing cover 13, the panel 11 will display a corresponding icon (such as an arrow or hand shape) which slides correspondingly. Herein for example, the touch can be implemented by the user's finger or stylus contacting or nearly contacting the touch-sensing cover 13. Moreover, the interaction with the graphical user interface can be, for example, that the user touches the touch-sensing cover 13 by the finger to execute the click, enlargement or movement. For example, when the user's finger taps the touch-sensing cover 13 at a position, the panel 11 will execute the item located at the corresponding position. Thereby, the item displayed on the panel 11 can be directly controlled and executed through the touch-sensing cover 13, and that means the shadeless touch can be achieved. The above-mentioned touch can include, for example, an operation gesture or hand gesture, such as a single tap or multiple taps, a single slide or multiple slides (such as a rightward, leftward, upward or downward slide), sequential clicks by multiple fingers, or simultaneous slide by multiple fingers. Besides, the operation of the hand-held electronic device 1 in response to the hand gesture can be determined by factory settings and/or according to the user's usage. Therefore, as shown in FIG. 1, the user can view the content displayed on the panel 11 through the front side of the hand-held electronic device 1 and execute the input operation through the touch-sensing cover 13 of the back side.

The touch-sensing structure 132 provides a plurality of detection points for providing an input position. The area of the touch-sensing structure 132 of the touch-sensing cover 13 is less than that of the panel 11 in this embodiment, and the areas have a ratio relationship, which will be used by the control unit 12 converting the touch points of the touch-sensing cover 13 into the corresponding positions of the panel 11. Although the area of the touch-sensing structure 132 is less than that of the panel 11 in this embodiment, the area of the touch-sensing structure 132 may be equal to (even larger than) that of the panel 11 in another embodiment, which may occur when the touch-sensing structure 132 is extended to the sidewall of the touch-sensing cover 13.

When the user executes the touch operation on the touch-sensing cover 13 by finger for example, the panel 11 can display the corresponding operation according to the user's operation gesture (or called the hand gesture), wherein the control unit 12 will convert the input position of the touch-sensing structure 132 into the display position of the panel 11, and the panel 11 will display a visible sign (such as an icon) at the display position so that the user can interact with the graphical user interface displayed on the panel 11.

Moreover, in one embodiment where the shadeless touch hand-held electronic device 1 is used in the strong light environment such as the outdoor sunlight or indoor high-illuminance light, the user can operate the shadeless touch hand-held electronic device 1 by a single hand while the touch-sensing cover 13 faces the light source of the strong light environment (the panel 11 faces the user) and the back of the panel 11 faces the light source of the strong light environment, so the touch-sensing cover 13 can block the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device 1 under the strong light source (such as the sunlight). Besides, in comparison with the conventional art where just the thumb can be used in the single-hand operation, the operation on the touch-sensing cover 13 by the forefinger or middle finger can provide more flexibility and a new user experience about the single-hand holding and multi-finger touch operation.

Moreover, in addition to being disposed on the cover body 1311 and the sidewall 1312, the touch-sensing structure 132 also can be disposed at other places of the hand-held electronic device 1 which won't cover the panel 11, such as the top surface and bottom surface, according to different requirements. Therefore, when the user executes the operation on the touch-sensing cover 13, as shown in FIG. 1, the display of the panel 11 won't be shaded by the fingers and the erroneous touch can be thus avoided. Besides, other advantages of providing the touch-sensing cover 13 for the user's touch operation include that the touch-sensing cover 13 needn't be made by the transparent touch-sensing material (such as ITO) for matching the display performance of the panel 11, and therefore the material selection will be more flexible and the cost can be controlled more easily.

The touch-sensing structure 132 can be disposed on the inner surface of the cover 131 facing the panel 11 (i.e. the inside of the hand-held electronic device 1) and/or on the outer surface of the cover 131 against the panel 11 (i.e. the outside of the hand-held electronic device 1). Herein for example, the touch-sensing structure 132 is a capacitive touch structure and formed on the inner surface of the cover 131 facing the panel 11, and is directly formed on the cover body 1311 and the two sidewalls 1312. In another embodiment where the touch-sensing structure 132 is disposed on the outer surface of the cover 131 against the panel 11, a protection layer is required for protecting the touch-sensing structure 132. To be noted, the material of the cover 131 can be glass or other materials, and the cover 131 is a part of the whole structure of the hand-held electronic device 1. In other words, the touch-sensing cover 13 is not an additional component (such as the protection cover of the electronic device), so if the touch-sensing cover 13 is separated from the hand-held electronic device 1, the inside components of the hand-held electronic device 1, such as battery or integrated circuit, can be seen. Moreover, the touch-sensing structure 132 also can be disposed around some places of the cover 131 where the camera lens or flash light is disposed for example. In one embodiment, a circuit board, a battery or a memory card can be disposed between the touch-sensing cover 13 and the panel 11. Besides, the touch-sensing structure 132 can include a transmitter circuit and a receiver circuit (i.e. the so-called Tx and Rx, not shown), and the material thereof can be conducting (film) layer (such as a transparent conducting layer, including indium tin oxide (ITO), indium zinc oxide (IZO), fluorine-doped tin oxide (FTO), Al-doped ZnO, Ga-doped ZnO for example), metal nanowires, graphene, carbon nanotubes or metal mesh, but this invention is not limited thereto. If the metal mesh, metal nanowires or graphene is used as the material of the touch-sensing structure 132, the Tx and Rx also can be capable of the wireless information or power transmission (such as the Bluetooth communication or wireless charging).

If the touch-sensing structure 132 is made by metal mesh, the metal texture effect can be exhibited on the appearance when the touch-sensing structure 132 is disposed on the outer surface (not the display surface) of the cover 131. Accordingly, because the metal texture effect can be achieved just by disposing the touch-sensing structure 132 composed of the metal mesh on the outer surface (not the display surface) of the cover 131 made by non-metal material, the metal-made cover (requiring a more complicated process) is not necessary to be used, so as to further achieve the effect of saving the cost.

In one embodiment, the hand-held electronic device 1 can further include another touch-sensing structure (not shown), which can be disposed on the panel 11 so that the panel 11 becomes a touch display panel. Therefore, the user can execute the shadeless touch operation on the cover 131, and also can use another touch-sensing structure for the interaction with the device. Accordingly, the user can choose to execute the shadeless touch operation on the cover 131, or choose to operate the hand-held electronic device 1 directly on the touch display panel, or choose to operate the hand-held electronic device 1 on the cover 131 and the touch display panel at the same time.

As shown in FIG. 2, the control unit 12 is disposed on the circuit board which is disposed inside the hand-held electronic device 1 and can be composed of at least a processing chip. The control unit 12 can control not only the content displayed on the panel 11 but also the operation of the touch-sensing cover 13. The storage unit 14 is a storing medium of the hand-held electronic device 1, and can be the memory inside the hand-held electronic device 1 or outside the hand-held electronic device 1 (such as the cloud memory or cloud storage), but this invention is not limited thereto. The storage unit 14 can include, for example, ROM (Read-Only Memory), RAM (Random Access Memory), flash, field-programmable gate array (FPGA) or other kinds of memory. Besides, one or more programs can be stored in the storage unit 14 and can be executed by the control unit 12 (including one or more processors). Furthermore, the storage unit 14 also can store the operation system, application programs, data processing programs and electronic data of various formats. The operation system is the program managing the computer hardware and software resources. The application program can be a word processing program, email program or others. In this embodiment, the control unit 12 includes a central processing unit (CPU) for example to execute the programs.

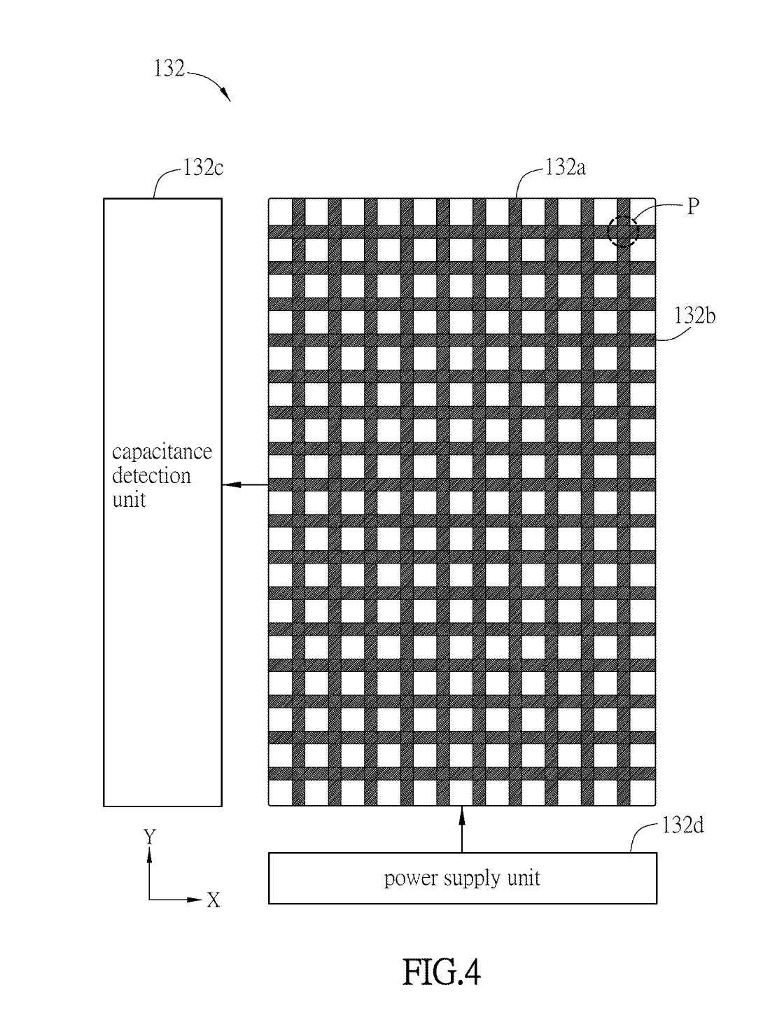

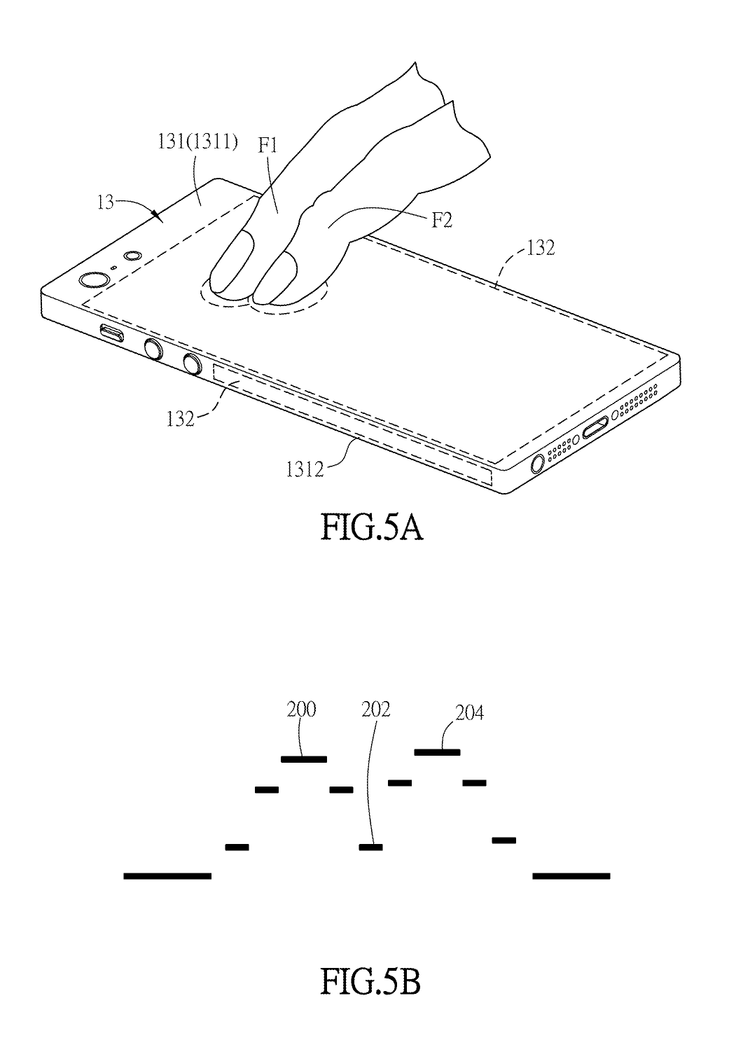

Then, referring to FIGS. 4 and 5A, FIG. 4 is a schematic block diagram of the touch-sensing cover of an embodiment of the invention and FIG. 5A is a schematic diagram showing the user uses two fingers to operate the touch-sensing cover.

The touch-sensing structure 132 of this embodiment can include a first sensing layer 132a, a second sensing layer 132b, a capacitance detection unit 132c and a power supply unit 132d.

The first sensing layer 132a and the second sensing layer 132b are electrically connected with the capacitance detection unit 132c through a circuit. The first sensing layer 132a has a plurality of first sensing lines which are disposed along the first direction X (such as the horizontal direction). The second sensing layer 132b is disposed opposite the first sensing layer 132a and has a plurality of second sensing lines which are disposed along the second direction Y (such as the vertical direction). The first sensing layer 132a and the second sensing layer 132b are spatially separated from each other. In physical, the first sensing layer 132a and the second sensing layer 132b are located on the different planes (the first sensing layer 132a and the second sensing layer 132b can be electrically insulated from each other by an insulating layer). Moreover, the first sensing lines and the second sensing lines cross each other to form a plurality of detection points P. The power supply unit 132d can send voltage signals to the second sensing lines. Accordingly, because the first sensing lines and the second sensing lines are close to each other and they are all conductors, each of the overlaps (i.e. the detection points P) between the first sensing lines and the second sensing lines has a coupling capacitance. To be noted, in this embodiment, the first sensing layer 132a and the second sensing layer 132b are disposed on the inner surface of the cover 131 facing the panel 11, so an insulating layer (not shown) is required between the first sensing layer 132a and the second sensing layer 132b for their electrical insulation. However, in other embodiments, the first sensing layer 132a is disposed on the inner surface of the cover 131 facing the panel 11 while the second sensing layer 132b is disposed on the outer surface of the cover 131 against the panel 11 (and vice versa), the cover 131 disposed between them can act as the material for their insulation and the insulating layer here is unnecessary. Besides, in one embodiment, the first sensing layer 132a or the second sensing layer 132b (i.e. a part of the touch-sensing structure 132) of the touch-sensing structure 132 can be applied to the wireless power transmission (such as the wireless charging). Moreover, in one embodiment, the density of the detection points P of the touch-sensing structure 132 disposed on the cover body 1311 (the first touch-sensing structure) can be equal to that of the detection points P of the touch-sensing structure 132 disposed on the sidewall 1312 (the second touch-sensing structure). However, in another embodiment, the density of the detection points P of the first touch-sensing structure can be higher than that of the detection points P of the second touch-sensing structure. However, this invention is not limited thereto.

The capacitance detection unit 132c is electrically connected with the first sensing lines and the second sensing lines so as to detect the change of the coupling capacitance therebetween to provide the touch signal, and the touch signal can be transmitted to the control unit 12 so that the control unit 12 can execute the judgment or analysis to determine the selected object and the corresponding operation. For example, when the user's finger touches or nearly contacts a certain detection point P, the finger will change the charge coupling between the first sensing line and the second sensing line at the detection point P so as to change the capacitance of the detection point P. By the capacitance detection unit 132c detecting the change of the coupling capacitance between the first sensing line and the second sensing line, the touched position by the user's finger can be determined.

The capacitance detection unit 132c can include at least one sensor IC, which is used to detect the capacitance of each detection point P, convert the analog capacitance signal into the digital capacitance signal and then transmit the digital capacitance signal to the control unit 12 (not shown in FIG. 4) electrically connected with the capacitance detection unit 132c.

In other embodiments, at least a filter can be disposed between the first sensing lines and the capacitance detection unit 132c and can be formed by an inverting amplifier circuit for example. The filter can eliminate the parasitic capacitance of the touch-sensing structure, which comes from, for example, the capacitance effect between the first sensing lines, between the second sensing lines or between the sensing lines and the grounding level. In short, the filter can prevent the signal inputted to the capacitance detection unit 132c from being affected by the capacitance except the capacitance at the detection point P.

In other embodiments, for example, the touch-sensing structure may be a single-layer electrode structure. For example, the touch-sensing structure may include a plurality of sensing pads which are formed simultaneously, and the sensing pads may be in the form of a single-layer structure. The sensing pads may be a transparent conducting layer or a metal mesh. The shape of the sensing pad includes, for example but is not limited to, a triangle or a diamond shape, as long as they can help to achieve touch-sensing operations. Moreover, all sensing pads are unnecessary to have an identical shape.

The following is about the illustration of the touch-sensing structure 132 of the touch-sensing cover 13 receiving the multi-finger input and generating the corresponding operation.

Referring to FIGS. 5A and 5B, FIG. 5B is a schematic diagram showing the capacitance change caused by two fingers nonoverlapping each other after scanning the touch-sensing structure 132.

FIG. 5A is a schematic diagram showing the multiple fingers of the user that contacting the touch-sensing cover 13, but the manner of the fingers contacting the touch-sensing cover 13 and the number of the fingers contacting the touch-sensing cover 13 are not limited thereto. Although this embodiment shows that the operation is executed on the cover body 1311 of the cover 131, the operation also may be executed on the cover body 1311 and the sidewall 1312 by multiple fingers in other embodiments. In other words, the operation shown in the figures is not meant to be construed in a limiting sense.

Herein for example, the middle finger F1 and the forefinger F2 are used in the operation. When the middle finger F1 and the forefinger F2 simultaneously contact the touch-sensing structure 132 of the cover body 131, the capacitance detection unit 132c can detect a first peak value 200 and a second peak value 204. The first peak value 200 is the variation of the coupling capacitance corresponding to the middle finger F1 on the touch-sensing structure 132, and the second peak value 204 is the variation of the coupling capacitance corresponding to the forefinger F2 on the touch-sensing structure 132. Between the first peak value 200 and the second peak value 204 is a trough value 202, which is correspondingly generated by the interval between the two fingers. Therefore, by detecting the time difference between the occurrences of the first peak value 200 and second peak value 204 of the variation of the coupling capacitance or detecting the synchronous or relative motion between the fingers, the finger input gesture of the user can be determined, and the resulted finger touch signal can be transmitted to the control unit 12 for the corresponding operation. Those skilled in the art should comprehend that if the number of the fingers used in the operation is increased, the numbers of the peak value and tough value between the peaks and the applicability can be correspondingly increased. Accordingly, by the sequential or simultaneous touch or motion of the multiple fingers on the touch-sensing structure 132, various operations can be executed on the touch-sensing cover 13, and the user's view can be prevented from being shaded by the fingers during the operation.

Moreover, although the trough value 202 shown in FIG. 5B is a nonzero variation of the coupling capacitance, the tough value 202 also may be zero in other embodiments, and the trough value 202 will be varied with the different interval between the adjacent fingers.

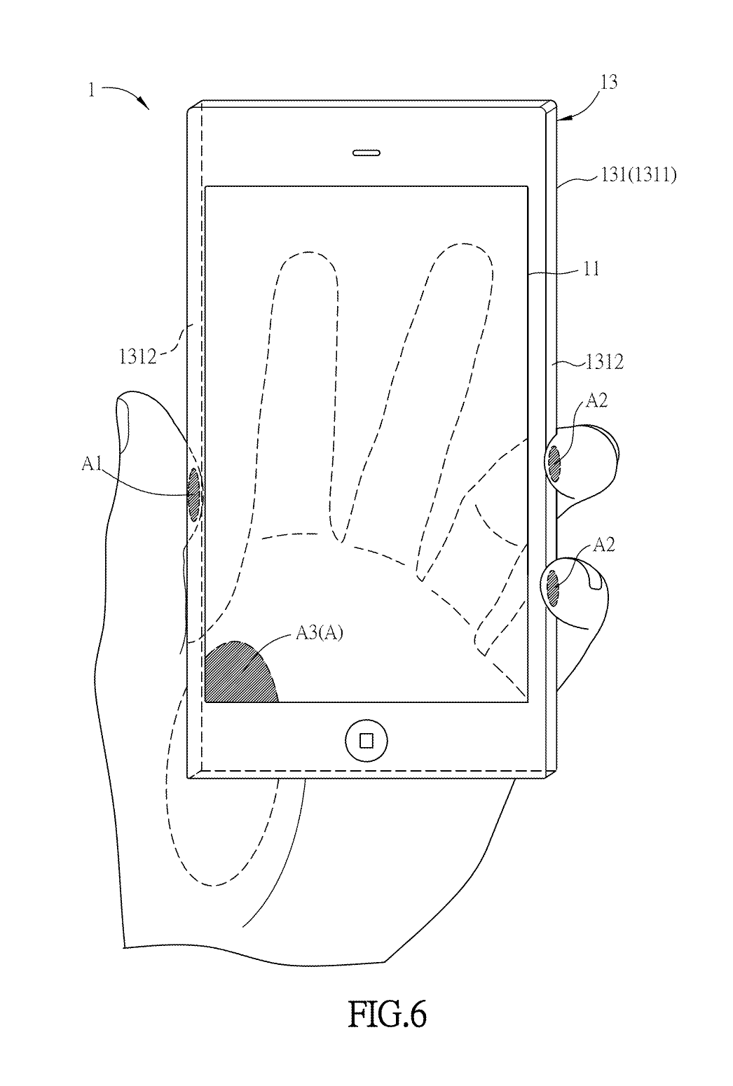

Referring to FIG. 6, FIG. 6 is a schematic diagram showing that the touch-sensing cover 13 of the hand-held electronic device 1 in FIG. 1 is triggered. The touch-sensing structure 132 is not shown in FIG. 6.

In physical, when the user operates the hand-held electronic device 1, the holding usage of the user can be preset, and the control unit 12 can analyze the trigger quantity distribution, trigger time, trigger frequency, trigger morphology or trigger location that is made by triggering the detection points from the user when operating the setting interface. The trigger quantity distribution, trigger time, trigger frequency, trigger morphology or trigger location can be defined as the initiative determination condition and stored in the storage unit 14. In other words, the holding position or usage of the user operating the hand-held electronic device 1 can be defined as the initiative determination condition. For example, as shown in FIG. 6, when the user holds the hand-held electronic device 1, the control unit 12 can analyze the triggered detection point at the holding position and define the region where the number of the adjacent triggered detection point is larger than a predetermined value as a triggered area A. In this embodiment, according to the trigger quantity distribution of the detection point P, one of the sidewalls 1312 has a trigger area A1, the other sidewall 1312 has two trigger areas A2, and the cover body 1311 has a trigger area A3. In other words, in this embodiment, the trigger quantity distribution and the trigger location indicate the quantity and location of each trigger area, respectively, and the trigger morphology indicates the shape or appearance of each trigger area A, i.e. the shapes or appearance of the trigger areas A1, A2 and A3. Moreover, the trigger frequency indicates the click frequency at a certain location, and the trigger time indicates that the holding time exceeds a certain time or is related to the user's living habit.

After the setting is accomplished, the control unit 12 will compute the trigger quantity distribution, trigger time, trigger frequency, trigger morphology or trigger location of the detection points on the touch-sensing cover 13 at predetermined time intervals. Therefore, when the user's finger touches the touch-sensing cover 13, the control unit 12 can compute the trigger quantity distribution, trigger time, trigger frequency, trigger morphology or trigger location of the triggered detection point after receiving the touch signal, and can compare the obtained trigger quantity distribution, trigger time, trigger frequency, trigger morphology or trigger location with the initiative determination condition which is pre-stored in the hand-held electronic device 1.

If the trigger quantity distribution, trigger time, trigger frequency, trigger morphology or trigger location conforms to the initiative determination condition, the touch-sensing structure 132 is permitted to receive at least an input action inputted by the user. In other words, on the premise that the trigger quantity distribution, trigger time, trigger frequency, trigger morphology or trigger location conforms to the initiative determination condition, the control unit 12 just can execute other actions to permit the touch-sensing structure 132 to receive the user's input action. Therefore, when other users want to hold and operate the hand-held electronic device 1, the operation thereof will be forbidden because the trigger quantity distribution, trigger time, trigger frequency, trigger morphology or trigger location doesn't conform to the initiative determination condition set by the original user, and therefore the security of the hand-held electronic device 1 can be enhanced.

To be noted, if the trigger morphology exhibits a plurality of surface contacts, it will be directly judged not to conform to the initiative determination condition. The above multiple surface contacts denote two or more surface contacts. In this embodiment, the surface contact denotes that the diameter of a single trigger area that the user contacts on the touch-sensing cover 13 or the longest distance from an edge of the contact to the other edge of the contact is 7mm or more. The case of the multiple surface contacts is easily caused when the user just purely holds the hand-held electronic device 1 instead of touching or operating the hand-held electronic device 1, so the trigger event caused thereby is directly judged not to conform to the initiative determination condition.

Moreover, in the case of the trigger morphology of the trigger event exhibiting a single surface contact, the initiative determination can be made according to the position of the single surface contact. For example, when the position of a single surface contact is on the upper portion of the hand-held electronic device, it is also judged not to conform to the initiative determination condition. The above configuration is based on that if the user normally holds the hand-held electronic device and executes the touch operation on the touch-sensing cover by finger, the palm of the user may be located at the lower portion of the hand-held electronic device to form the trigger area of a surface contact instead of forming the trigger area of a surface contact at the upper portion. Besides, when the finger executing the touch operation at the upper portion contacts the touch-sensing cover to form a trigger area, the diameter of the trigger area or the longest distance from an edge of the contact to the other edge of the contact is often not larger than 7mm. Therefore, when the position of a single surface contact is located on the upper portion of the hand-held electronic device, it is quite possible that the user may clean the cover or purely hold the hand-held electronic device instead of executing the touch operation. Herein, the upper portion or the lower portion can be defined according to the center of the cover or the center of the touch-sensing structure and in the situation of the user operating the hand-held electronic device. The portion above the center is the upper portion while the portion below the center is the lower portion.

In other embodiments, the hand-held electronic device 1 can further include a fingerprint recognition unit (not shown), which is electrically connected with the control unit 12 and can recognize the fingerprint of at least one finger. Therefore, the user can store the fingerprint thereof in the storage unit 14 in advance, and when wanting to activate the hand-held electronic device 1, the user can touch, for example, a certain region of the cover body 1311 of the touch-sensing cover 13 by finger, and the control unit 12 can compare the fingerprint in the certain region with the pre-stored fingerprint. If the fingerprints match each other, the hand-held electronic device 1 can be activated to receive the user's input action. If the fingerprints don't match each other, the control unit 12 will judge that the user is not a permitted user so that the hand-held electronic device 1 can't be activated. In other embodiments, the hand-held electronic device 1 can further include a palmprint recognition unit (not shown), which is electrically connected with the control unit 12 and can recognize at least a part of the palmprint of the user. Therefore, the user can store the palmprint thereof in the storage unit 14 in advance, and when wanting to activate the hand-held electronic device 1, the user can touch, for example, a certain region of the cover body 1311 of the touch-sensing cover 13 by the palm, and the control unit 12 can compare the palmprint in the certain region with the pre-stored palmprint. If the palmprints match each other, the hand-held electronic device 1 can be activated to receive the user's input action. If the palmprints don't match each other, the control unit 12 will judge that the user is not a permitted user so that the hand-held electronic device 1 can't be activated. The above input action includes, for example but is not limited to, opening a webpage, reading the email content, executing APPs, etc.

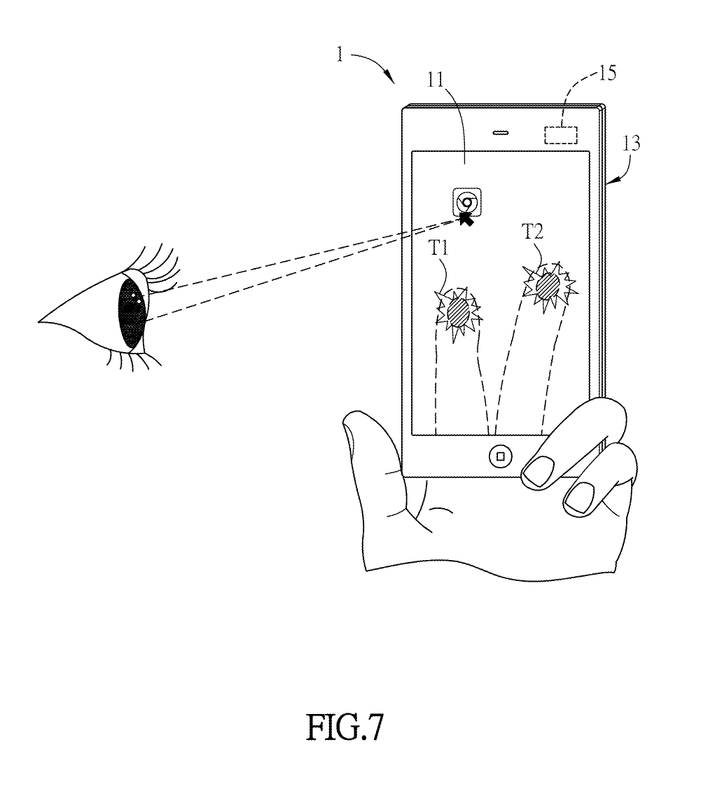

FIG. 7 is a schematic diagram showing another operation of the hand-held electronic device 1.

As shown in FIG. 7, the hand-held electronic device 1 can further include an eyeball tracking module 15, which is electrically connected with (not shown) the control unit 12. The eyeball tracking module 15 of this embodiment can be an eye tracking device, a camera, a video device or an infrared detecting device and can detect and acquire the eyeball information of the user. The eyeball information can be an eye image, eye coordinates or their combination for example. The eyeball information acquired by the eyeball tracking module 15 contains a position information corresponding to the panel 11, and the position information will correspond to at least an object displayed on the panel 11. To be noted, the position information is unnecessary to be completely the same as the focus of the eyes of the user, and can be modified to provide the position of the object which is closest to the focus of the user's eyes. That is, for the convenience of the user selecting the object, the position information will be automatically modified to provide the position of the nearest object.

As shown in FIG. 7, the panel 11 can display an arrow for example at the position corresponding to the position information so that the user can know the position corresponding to the position information. When the eyeball information of the user is changed, the position information (arrow) on the panel 11 will be moved correspondingly.

As shown in FIGS. 4 to 7, the eyeball information acquired by the eyeball tracking module 15 working with the finger input detection will be illustrated as below. The all operation gestures (hand gestures) as below are the touch operation gestures implemented by the user's finger on the touch-sensing cover 13. Besides, the finger input detection of this embodiment can be applied to the above hand-held electronic device 1, but this invention is not limited thereto. The method of detecting the finger input includes the following steps. First, the eyeball information, such as the eye image, eye coordinates or their combination, can be acquired by the eyeball tracking module 15. Then, the eyeball information has the position information corresponding to the panel 11, and the position information can correspond to at least an object displayed on the panel 11. The object can be an icon for example, which corresponds to an application program. The position information of this embodiment can be correspondingly shifted to the position of the object which is closest to the position information.

Then, the touch-sensing structure 132 is scanned, so as to detect the change of the coupling capacitances between the first sensing lines and the second sensing lines of the touch-sensing structure 132 (i.e. the change of the coupling capacitance at the detection point P). When a finger touches the touch-sensing structure 132 (by a click or contact), the coupling capacitance will be changed and a touch signal is thus generated, and the touch signal will be transmitted to the control unit 12. The control unit 12 of the hand-held electronic device 1 will determine, according to the touch signal, the selected object, i.e. the corresponding object of the position information (arrow). The object to be selected can be given a visible sign (such as a color change). In other embodiments, the visible sign also can be a prompt box, a shape change (such as a bigger shape), a flash of the selected object, or a displayed sign near the selected object.

The hand-held electronic device 1 will determine the selected object according to the touch signal and also execute the instruction corresponding to the object. In other words, when the touch-sensing structure 132 detects the change of the coupling capacitance caused by, for example, a click or double clicks, the hand-held electronic device 1 will execute the application program corresponding to the object corresponding to the position information. For example, after a single tap to select the browser shortcut icon, the browser will be executed.

Moreover, in the situation of the multi-finger input where the user uses another finger to touch the touch-sensing structure 132 for example (at this time, the touch-sensing structure 132 receives two touch signals T1, T2), the control unit 12 will analyze the two touch signals T1, T2 inputted at two different timings to give the corresponding operation such as moving the selected object. Accordingly, when two fingers continuously touch the touch-sensing structure 132 with a movement, the object displayed on the panel 11 will exhibit a corresponding movement in response to the moving path of the two fingers. To be noted, this embodiment just illustrates the input of a single or multiple fingers and the corresponding operations on the touch-sensing structure 132, but those skilled in the art can develop many variations accordingly.

In one embodiment, the hand-held electronic device 1 can further include a wireless communication unit (not shown), which includes a wireless communication chip and an antenna. The wireless communication chip is electrically connected with the control unit 12, and the antenna can be disposed on a part of the cover 131 or the touch-sensing structure 132 for example, but this invention is not limited thereto. When the user wants to communicate with another electronic device through the near field communication (NFC), the hand-held electronic device 1 can be made closer to another electronic device capable of the near field communication function to receive or transmit data through the antenna and the wireless communication chip.

To be noted, the features of the above embodiments can be implemented separately or together.

Summarily, in the shadeless touch hand-held electronic device and the touch-sensing cover thereof according to the invention, the user can execute the touch operation on the touch-sensing cover of the shadeless touch hand-held electronic device, so the finger of the user can't shade the view or the software object displayed on the panel, and also the touch for opening the link of the high information density image won't be erroneously executed. Besides, since the manipulation for the electronic device is executed on the touch-sensing cover, the panel scratch situation can be reduced. Furthermore, because the user can execute the touch operation on the touch-sensing cover, the user can use multiple fingers such as the forefinger and middle finger to operate the electronic device while using the same hand holding the device. In comparison with the conventional art where the user just can use the thumb to execute the operation while using the same hand holding the device, this invention can provide more manual efficiency and convenience and can realize a better user experience.

In one embodiment, the shadeless touch hand-held electronic device is used in the strong light environment such as the outdoor sunlight or indoor high-illuminance light, the user can operate the shadeless touch hand-held electronic device by a single hand while the touch-sensing cover faces the light source of the strong light environment (or the panel faces the user) and the panel's back faces the light source of the strong light environment, so the touch-sensing cover can shade the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device under the strong light source (such as the sunlight). Besides, in comparison with the conventional art where just the thumb can be used in the single-hand operation, the operation on the touch-sensing cover by the forefinger or middle finger can provide more flexibility and a new user experience with single-hand holding and multi-finger touch operation.

Additionally, on the premise that the trigger quantity distribution, trigger time, trigger frequency, trigger morphology or trigger location conforms to the initiative determination condition, the hand-held electronic device just can execute other operations. Therefore, when other users want to operate the hand-held electronic device, the operation thereof will be forbidden because the trigger quantity distribution, trigger time, trigger frequency, trigger morphology or trigger location doesn't conform to the initiative determination condition set by the original user, and therefore the security of the hand-held electronic device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch-sensing cover of a shadeless touch hand-held electronic device comprising a panel and a control unit, the touch-sensing cover comprising:
a cover comprising a cover body and a sidewall extended from at least a part of an edge of the cover body; and
a touch-sensing structure, at least a part of which is disposed on the cover body, wherein the touch-sensing structure comprises a plurality of detection points for providing an input position, the area of the touch-sensing structure and the area of the panel have a ratio relationship, the control unit converts the input position into a display position of the panel according to the ratio relationship, and the panel displays a visible sign at the display position,
wherein the cover is disposed on the side of the shadeless touch hand-held electronic device opposite the panel, and the touch-sensing structure is electrically connected with the control unit, so that a user operates the shadeless touch hand-held electronic device by the touch-sensing cover.

2. The touch-sensing cover as recited in claim 1, wherein the touch-sensing structure is disposed on an inner surface of the cover facing the panel or on an outer surface of the cover against the panel, or a part of the touch-sensing structure is disposed on an inner surface of the cover facing the panel and another part of the touch-sensing structure is disposed on an outer surface of the cover against the panel

3. The touch-sensing cover as recited in claim 1, wherein the touch-sensing structure comprises metal mesh, metal nanowires, transparent conducting film, carbon nanotubes or graphene.

4. The touch-sensing cover as recited in claim 1, wherein the touch-sensing structure is further extended to at least one sidewall.

5. The touch-sensing cover as recited in claim 1, wherein the control unit computes a trigger quantity distribution, trigger time, trigger frequency, trigger morphology or trigger location of the detection points at predetermined time intervals and compares the trigger quantity distribution, trigger time, trigger frequency, trigger morphology or trigger location with an initiative determination condition which is pre-stored in the shadeless touch hand-held electronic device.

6. The touch-sensing cover as recited in claim 5, wherein when the trigger quantity distribution, trigger time, trigger frequency, trigger morphology or trigger location conforms to the initiative determination condition, the touch-sensing structure is permitted to receive at least an input action inputted by the user.

7. The touch-sensing cover as recited in claim 1, wherein the shadeless touch hand-held electronic device further comprises an eyeball tracking module, the eyeball tracking module acquires an eyeball information, the eyeball information comprises a position information corresponding to the panel, and the position information corresponds to an object displayed on the panel.

8. The touch-sensing cover as recited in claim 1, wherein the shadeless touch hand-held electronic device further comprises a wireless communication unit, which comprises a wireless communication chip and an antenna, the wireless communication chip is electrically connected with the control unit, and the antenna is disposed on the cover or the touch-sensing structure.

9. The touch-sensing cover as recited in claim 1, wherein the user operates the shadeless touch hand-held electronic device by a single hand.

10. The touch-sensing cover as recited in claim 1, wherein a part of the touch-sensing structure is capable of a wireless power transmission.

11. A shadeless touch hand-held electronic device, comprising:
a panel;
a control unit;
a touch-sensing cover, comprising:
a cover disposed on the side of the shadeless touch hand-held electronic device opposite the panel, and comprising a cover body and a sidewall extended from at least a part of an edge of the cover body; and
a touch-sensing structure, at least a part of which is disposed on the cover body, wherein the touch-sensing structure comprises a plurality of detection points for providing an input position, the area of the touch-sensing structure and the area of the panel have a ratio relationship, the control unit converts the input position into a display position of the panel according to the ratio relationship, and the panel displays a visible sign at the display position,
wherein the touch-sensing structure is electrically connected with the control unit, so that a user operates the shadeless touch hand-held electronic device by the touch-sensing cover.

12. The shadeless touch hand-held electronic device as recited in claim 11, wherein the touch-sensing structure is disposed on an inner surface of the cover facing the panel or on an outer surface of the cover against the panel, or a part of the touch-sensing structure is disposed on an inner surface of the cover facing the panel and another part of the touch-sensing structure is disposed on an outer surface of the cover against the panel.

13. The shadeless touch hand-held electronic device as recited in claim 11, wherein the touch-sensing structure comprises metal mesh, metal nanowires, transparent conducting film, carbon nanotubes or graphene.

14. The shadeless touch hand-held electronic device as recited in claim 11, wherein the touch-sensing structure is further extended to at least one sidewall.

15. The shadeless touch hand-held electronic device as recited in claim 11, wherein the control unit computes a trigger quantity distribution, trigger time, trigger frequency, trigger morphology or trigger location of the detection points at predetermined time intervals and compares the trigger quantity distribution, trigger time, trigger frequency, trigger morphology or trigger location with an initiative determination condition which is pre-stored in the shadeless touch hand-held electronic device.

16. The shadeless touch hand-held electronic device as recited in claim 15, wherein when the trigger quantity distribution, trigger time, trigger frequency, trigger morphology or trigger location conforms to the initiative determination condition, the touch-sensing structure is permitted to receive at least an input action inputted by the user.

17. The shadeless touch hand-held electronic device as recited in claim 11, further comprising:
an eyeball tracking module, which acquires an eyeball information, wherein the eyeball information comprises a position information corresponding to the panel, and the position information corresponds to an object displayed on the panel.

18. The shadeless touch hand-held electronic device as recited in claim 11, further comprising:
a wireless communication unit, which comprises a wireless communication chip and an antenna, wherein the wireless communication chip is electrically connected with the control unit, and the antenna is disposed on a part of the cover or the touch-sensing structure.

19. The shadeless touch hand-held electronic device as recited in claim 11, wherein the user operates the shadeless touch hand-held electronic device by a single hand.

20. The shadeless touch hand-held electronic device as recited in claim 11, wherein a part of the touch-sensing structure is capable of a wireless power transmission.
